(19) United States
(12) Patent Application Publication
(10) Pub. No.: US 2024/0172824 A1
(43) Pub. Date: May 30, 2024

(54) Protective Garment With Bio-Based Treatment

(71) Applicant: Burlington Industries LLC, Greensboro, NC (US)

(72) Inventors: William J. DiIanni, Kernersville, NC (US); Kiarash Arangdad, Greensboro, NC (US)

(21) Appl. No.: 18/512,838

(22) Filed: Nov. 17, 2023

Related U.S. Application Data
(60) Provisional application No. 63/426,431, filed on Nov. 18, 2022.

(51) Int. Cl. A41D 31/10; A41D 3/02; A41D 13/12; A41D 31/08; A41D 31/30; A62B 17/00

(52) U.S. Cl. CPC A41D 31/10; A41D 3/02; A41D 13/1227; A41D 31/085; A41D 31/30; A62B 17/003

(57) ABSTRACT

Fabric materials and garments are disclosed that have been treated with a water resistant treatment composition. The water resistant treatment composition contains a bio-based water repellent. The composition of the present disclosure can be formulated with a minimal amount of components and has been found to provide not only excellent water resistant properties but also is very durable once applied to a fabric.

### RELATED APPLICATIONS

The present application is based upon and claims priority to U.S. Provisional Patent Application Ser. No. 63/426,431, having a filing date of Nov. 18, 2022, and which is incorporated herein by reference.

### BACKGROUND

High performance protective garments, including fire resistant garments, should be as light as possible, should provide some breathability and should encumber the wearer as little as possible. In this regard, many protective garments are made with water resistant properties. Garments that absorb liquids, such as moisture, for instance, can increase in weight while being worn and can decrease in air permeability.

Consequently, in the past, many protective garments were treated with a water resistant finish. Conventional water resistant finishes typically contained fluorinated compounds. In addition to fluorinated compounds, the water resistant treatments also contained various fossil-based polymers, including polyurethanes. Fluorinated compounds have recently been subject to governmental scrutiny. Replacing fluorinated compounds, however, with fossil-based polymers leads to greater carbon emissions.

In view of the above, a need exists for a protective garment that includes a water resistant treatment that is not only free of fluorinated compounds, but also is formed from non-fossil-based polymers.

### SUMMARY

In general, the present disclosure is directed to a water resistant treatment that can provide fabric materials with effective liquid resistant properties that is made at least in part from non-fossil-based components and optionally also contains no fluorinated compounds. The present disclosure is also directed to protective garments treated with the water resistant treatment. The protective garments can be used in all different industries including the healthcare field, in industrial settings, or by first responders. In one aspect, the protective garment can also have fire resistant properties by being formed from inherently flame resistant fibers.

In one embodiment, the present disclosure is directed to a protective garment comprising a fabric material. The fabric material can be a woven fabric, a knitted fabric, a nonwoven fabric, or combinations thereof. The fabric material includes a water resistant treatment in accordance with the present disclosure. The water resistant treatment comprises a water repellent. The water repellent has a mean bio-based carbon content of at least about 25%, such as at least about 30%, such as at least about 40%, such as at least about 50%, such as at least about 60%, such as at least about 70%, such as at least about 80%, such as even at least about 90%. In addition, the fabric material treated with the water resistant treatment can have a fluorine content (as an impurity) of less than about 5000 ppb, such as less than about 1000 ppb, such as less than about 500 ppb, such as less than about 100 ppb. The fabric material can display a water absorbency of less than about 15%, such as less than about 5%, after fifty laundry cycles.

The bio-based water repellent can vary depending upon the particular application. In one embodiment, the bio-based water repellent is an acrylate, such as an alkylacrylate. In an alternative embodiment, the bio-based water repellent is a hyperbranched hydrocarbon polymer. The hyperbranched hydrocarbon polymer can have a dendritic structure with C1 to C4 alkyl end groups, such as methyl end groups and can contain water repellent end groups. In one aspect, the hyperbranched hydrocarbon polymer can be combined with a comb polymer. In addition, the bio-based water repellent composition can optionally include hydrophobizing agents such as natural waxes (e.g carnauba wax). The bio-based water repellent can also contain fillers, particularly natural based filler materials, such as microcrystalline cellulose. The natural based filler material can enhance the surface roughness in order to provide a high level of hydrophobicity.

The composition of the present disclosure can also contain various other optional ingredients. For instance, composition can also include natural-based insect repellent/insecticide chemistries such as oil of lemon eucalyptus, peppermint oil, synthetic permethrin, IR 3535, etofenprox, hydrophobic silicone softeners and the like. The composition can also contain antimicrobial agents, such as metal-based/non-metal-based chemistries including silver based inorganic agents, silver and zinc zeolites, silver copper zeolites, silver zeolites, metal oxides, silicates, and quaternary ammonium compounds. Other components can include flame retardants (e.g., phosphorous compounds, melamine derivatives, antimony compounds), optical brighteners (e.g., bis-benzoxazoles, phenylcoumarins, and bis-(styryl)biphenyls)), and/or anti-static additives (e.g., such as fatty acid esters, ethoxylated alkylamines and ethoxylated alcohols, alkylsulfonates and alkylphosphates).

The water resistant treatment can also include a curing extender. The curing extender can vary depending upon the particular application. In one embodiment, the curing extender can also be bio-based. One example of a curing extender is a dialkylprazole compound. The curing extender can be a blocked isocyanate. The curing extender or crosslinking agent can also be a hydrophobically-modified polyacrylic acid polymer powder polymerized in a toxicologically-preferred cosolvent system. The hydrophobically-modified polyacrylic acid polymer allows for lower temperature (warm not hot) processing.

In one aspect, the water resistant treatment can contain the curing extender and the bio-based water repellent at a weight ratio of from about 1:2 to about 1:25, such as from about 1:3 to about 1:7.

In one aspect, the water resistant treatment forms a durable finish on the fabric material. The water resistant treatment, in one embodiment, does not form a coating on the fabric material, such as a continuous coating.

The water resistant treatment can be applied to fabric materials such that the fabric materials have a spray rating of at least 80 after 25 laundry cycles, such as at least 90 after 25 laundry cycles, such as even maintaining a spray rating of 100 after 25 laundry cycles. The fabric materials can also have a spray rating of at least 70 after 50 laundry cycles, such as at least 80 after 50 laundry cycles.

In one embodiment, the protective garment may be designed for fire service applications and may contain inherently flame resistant fibers. The inherently flame resistant fibers, for instance, may include para-aramid fibers, meta-aramid fibers, polybenzimidazole fibers, and mixtures thereof. In one embodiment, the outer shell material contains inherently flame resistant fibers in an amount of at least about 60% by weight. The fabric material can be formed from yarns of the inherently flame resistant fibers. The yarns can be multifilament yarns, spun yarns, stretch-broken yarns, monofilament yarns, and mixtures thereof. In one embodiment, the fabric material can be made from a combination of spun yarns and multifilament yarns. The fabric material can be woven, non-woven or knitted containing the inherently flame resistant fiber and yarns.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a perspective view of one embodiment of a front of a protective garment made in accordance with the present disclosure;

FIG. 2 is a perspective view of one embodiment of a back of a protective garment made in accordance with the present disclosure;

FIG. 3 is a perspective view of another embodiment of a protective garment made in accordance with the present disclosure;

FIG. 4 is a cross-sectional view of an inner liner that may be incorporated into the garment illustrated in FIG. 3;

FIGS. 5A-5F are diagrammatical views of illustrated examples of spray ratings for a standardized fabric spray test; and

FIG. 6 is a perspective view of one embodiment of a protective garment comprising trousers made in accordance with the present disclosure.

Repeat use of reference characters in the present specification and drawings is intended to represent the same or analogous features or elements of the present invention.

### DEFINITIONS AND STANDARDIZED PROCEDURES

The following definitions and procedures are offered in order to better describe and quantify the performance of protective garments and fabrics made according to the present invention in comparison to prior art constructions.

Fabrics and garments treated in accordance with the present disclosure can be used in numerous and diverse applications where water repellency is desired. For instance, fabrics and garments made according to the present disclosure can be used and worn by first responders, particularly those involved in firefighting, whether the garment is designed for firefighters in urban or rural areas or for use by firefighters that battle forest fires. The fabrics and garments of the present disclosure are also particularly well suited to constructing protective garments for industrial workers and for workers in the medical industry. The fabrics and garments of the present disclosure can also be used for outdoor apparel.

When used in the healthcare industry, for example, the protective garment of the present disclosure can be rated according to the Association for the Advancement of Medical Instrumentation (AAMI). The current AAMI standard is described in “Liquid Barrier Performance and Classification of Protective Apparel and Drapes Intended for Use in Health Care Facilities,” ANSI/AAMI PB70:2012. This AAMI standard helps to preserve the sterile field and protect health care workers during surgery and other health care procedures during which exposure to blood, body fluids and other potential infectious material might occur. This AAMI standard establishes a system of classification and associated minimum requirements for protective apparel such as gowns and drapes used in health care facilities based on their liquid barrier performance.

The present AAMI standard for liquid barrier performance is provided in the following table:

TABLE 1
AAMI Barrier Protection Levels

| AAMI | | | |
|---|---|---|---|
| Level | Test | Result | |
| 1 | AATCC 42: 2017e | ≤4.5 | grams |
| 2 | AATCC 42: 2017e | ≤1.0 | gram |
| | AATCC 127: 2017 | ≥20 | cm |
| 3 | AATCC 42: 2017e | ≤1.0 | gram |
| | AATCC 127: 2017 | ≥50 | cm |

| | | |
|---|---|---|
| 4 | Gowns: ASTM F1671/ | Pass |
| | F1671 M-13 | |
| | Drapes: ASTM | Pass |
| | F1670/F1670 M-17a | |

### Mean Bio-Based Content

The present disclosure is particularly directed to formulating a water resistant treatment containing a water repellent produced from sustainable resources for reducing reliance on fossil-based fuels. Consequently, in one aspect, the water repellent of the present disclosure has a mean bio-based carbon content of at least about 25%. In another example, the water-resistant material described here contains 90% carbon derived from natural sources.

Mean bio-based content can be determined according to ASTM Test D6866:2020-02.

Using a method that relies on determining the amount of radiocarbon dating isotope ¹⁴C (half life of 5730 years) in the compositions described herein can identify whether the carbon in these compositions derives from a biosource—from modern plant or animals—or from a fossil source, or a mixture of these. Carbon from fossil sources generally has a ¹⁴C amount very close to zero. Measuring the ¹⁴C isotope amount of the polyoxymethylene [POM] polymer itself, a POM intermediate, or an article containing the POM polymer can verify that the material or article derives from a biosource of carbon and quantify the percent of biosourced carbon.

ASTM D6866 Methods A-C can be used to determine the mean biobased content by ¹⁴C isotope determination, similar to radiocarbon dating. Determining the ¹⁴C amount via these methods gives a measure of the Mean Biobased Content of the tested material, i.e., the amount of biobased carbon of the tested material as a percent of the weight (mass) of its total organic carbon. Method B may be used in one embodiment.

The result of the ASTM D6866 method can also be reported as percent Modern Carbon [“pMC”]. pMC is the ratio of the amount of radiocarbon (¹⁴C) of the tested material relative to the amount of radiocarbon (¹⁴C) of the reference standard for radiocarbon dating, which is the National Institute of Standards and Technology-USA (NIST-USA) standard of a known radiocarbon content equivalent to that of the year 1950 CE. 1950 CE was chosen in part because it represents the period before the regular testing of thermonuclear weapons, which resulted in a large increase of excess radiocarbon in the atmosphere. For those using radiocarbon dates, 1950 CE equals “zero years old”. It also represents 100 pMC.

### Water Repellency: Spray Test AATCC TM22-2017.

As used herein, a fabric spray rating refers to a rating a fabric or a material receives according to AATCC TM22-2017. In general, a spray test measures the resistance of a material to wetting by water.

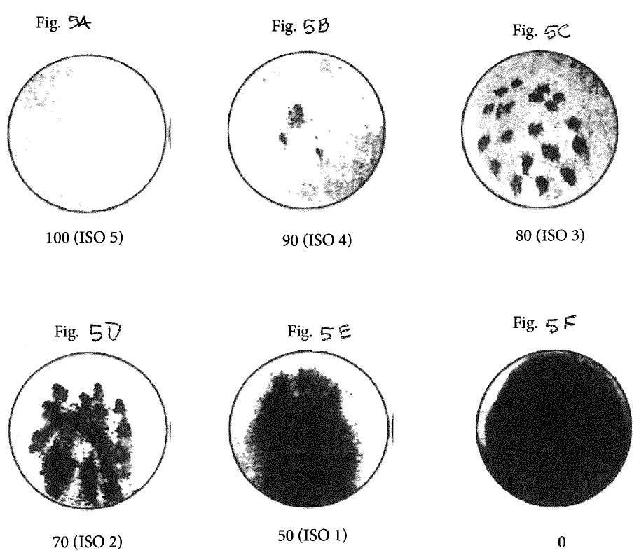

According to the present invention, the following is the procedure used to determine the spray rating of a material.
1. A 7″×7″ sample of the material to be tested is first conditioned at 65 plus or minus 2% relative humidity and at 70 plus or minus 2° F. for a minimum of four hours prior to testing.
2. The fabric sample is fastened securely on a 6″ metal hoop so that the fabric is wrinkle free. The hoop is supported on a tester's stand so that the fabric is facing up. Twills, gabardines, piques or similar fabrics of ribbed construction are positioned on the stand so that the ribs are diagonal to the flow of water running off the fabric. A funnel attached to a nozzle for holding water is placed 6″ above the center of the fabric.
3. 250 milliliters of water at 80 plus or minus 2° F. are poured from a cup or other container into the funnel, allowing the water to spray onto the fabric.
4. Once the water has run through the funnel, one edge of the hoop is held and the opposite edge is firmly rapped once against a solid object with the fabric facing the object. The hoop is then rotated 180° and it is rapped once more at the point previously held.
5. The wetted or spotted fabric sample is then compared with the standards shown in FIGS. 5A-5F. The fabric is assigned a spray rating that corresponds to the nearest standard. As shown on FIGS. 5A-5F, the fabric can be rated from 0 to 100 wherein 0 indicates that the entire fabric is wetted with the water, while a rating of 100 indicates that none of the fabric was wetted by the water.

### Aqueous Liquid Repellency: Water/Alcohol Solution Resistance Test (AATCC TM193-2017)

The following standardized water repellency test determines a material's resistance to wetting by aqueous liquids. In general, drops of a water-alcohol mixture of varying surface tensions are placed on the surface of the material and the extent of surface wetting is determined visually. The higher the rating a material receives is an indication of the material's resistance to staining by water-based substances. The composition of standard test liquids is as follows:

TABLE 1
Standard Test Liquids

Composition

| Water Repellency | | Distilled |
|---|---|---|
| Rating Number | Isopropanol, % | Water, % |
| 1 | 2 | 98 |
| 2 | 5 | 95 |
| 3 | 10 | 90 |
| 4 | 20 | 80 |
| 5 | 30 | 70 |
| 6 | 40 | 60 |
| 7 | 50 | 50 |
| 8 | 60 | 40 |

The water repellency procedure is as follows:
1. An 8″×8″ sample of material is first conditioned at 65 plus or minus 2% relative humidity and at 70 plus or minus 2° F. for a minimum of four hours. The fabric is placed horizontally face up on white blotting paper.
2. Beginning with test liquid number 1, one drop of the liquid is placed at three locations on the material. Each drop placed on the material should be 2″ apart.
3. The material is observed for 10 seconds from an approximate 45° angle.
4. If two of the three drops have not wet the fabric or do not show leaking into the fabric, drops of test liquid number 2 are placed on an adjacent site and step number 3 is repeated.
5. This procedure is continued until 2 of the 3 drops have wet or show wicking into the fabric. The water repellency rating is the highest numbered liquid for which 2 of the three drops do not wet or wick into the fabric.
   Dimensional Changes of Fabrics after Home Laundering AATCC TM135-2018

Laundering is preferably performed in an automatic washer, followed by drying in an automatic dryer. The following laundering test is used to determine the fabric's ability to withstand laundering. Typically, after laundering, the fabric is then subjected to the above-described spray test, water repellency test, and oil repellency test.
1. 8″×10″ test specimens are combined with load fabrics (hemmed pieces of cotton sheeting or 50:50 fabric sheets having a size of 36″×36″) to give a total dry load of 4 pounds.
2. The dials on the washer are set as follows:

| | |
|---|---|
| Water Level | High |
| Wash | Cycle Normal, 12 minutes |
| Temperature | Warm Wash, 105° F.; Cold Rinse |

The test pieces and dummy load are placed in the washer and the machine is started. One ounce of TIDE (Proctor & Gamble) detergent is added while the washer is filling with soft water. If the water hardness is greater than 5 ppm, CALGON water softener (Nalco) in the amount specified by the manufacturer is added to soften the water.
3. After the washing is complete, the wet fabric including the dummy load is placed in the automatic dryer. The dryer temperature dial is set to the proper point under high heat to give a maximum vent temperature of from about 155° F. to about 160° F. The time dial is set for “Normal Cycle” for 45 minutes. The machine is started and drying is allowed to continue until the cycle is complete. The above represents one laundry cycle.
4. The fabrics are then rewashed and redried until 10 cycles have been completed. Optionally, the test fabrics can be pressed with a hand iron, or the equivalent, at 280° F. to about 320° F. for 30 seconds on each side with the face side pressed last. The fabrics are then conditioned before testing for water is, repellency, oil repellency, or spray rating. As used herein, water repellency, oil repellency and spray ratings are all determined without ironing the fabric after being laundered, unless otherwise denoted.

### Water Absorption Resistance Test

The following water absorption test is for determining the resistance to water absorption of a fabric or material. The test is based upon NFPA 1971-2018, 8-25. In particular, the water absorption test is conducted according to the above-identified test method after the fabric or material has been subjected to five laundry cycles in accordance with NFPA 1971, 8-1.2 (or AATCC TM135-2018-1,V, Ai).

According to the present invention, the following is the procedure used to determine the water absorption rating of a material.
1. Three 8″×8″ samples of the material to be tested are subjected to five laundry cycles in accordance with NFPA 1971, 8-1.2. Test method NFPA 1972, 8-1.2 is substantially similar to the laundering test described above. In this test, however, the specimens are conditioned in an atmosphere of 70 plus or minus 2° F. and 65 plus or minus 2% relative humidity before and after being washed. Further, the machine settings and parameters are as follows:

| | |
|---|---|
| water level | normal |
| wash cycle | normal/cotton sturdy |
| wash temperature | 140 + or − 5° F. |
| drying cycle | tumble/cotton sturdy |
| detergent | 66 + or − 1 g of 1993 AATCC |
| | standard Reference Detergent |

2. Each sample is securely mounted, with the coated side of the material up, to embroidery hoops with sufficient tension to ensure a uniformly smooth surface. The hoop is supported on a tester's stand. The material is positioned so that the direction of the flow of water down the sample shall coincide with the warpwise direction of the sample as placed on the stand. A funnel attached to a nozzle for holding water is placed 24″ above the center of the material. The plane of the surface of the sample is placed at a 45° angle with the horizontal.
3. 500 ml of water at a temperature of 80 + or − 2° F. are poured quickly into the funnel and allowed to spray onto the specimen.
4. As rapidly as possible, the sample is removed from the hoops and placed between two sheets of blotting paper on a flat horizontal surface. A metal roller approximately 4½″ long and weighing 2¼ pounds is rolled quickly forward and back one time over the paper without application of any pressure other than the weight of the roller.
5. A square having dimensions of 4″×4″ is cut out of the center of the sample and weighed to the nearest 0.05 grams. Not more than 30 seconds shall elapse between the time the water has ceased flowing through the spray nozzle and the start of the weighing.
6. The same 4″×4″ square sample is then left in a conditioning room until it has dried and reached moisture equilibrium with the surrounding atmosphere. The sample is then weighed again.
7. The water absorbed shall be calculated as follows:

$$water absorbtion , percent = \frac{W - O}{O} \times 100$$

herein W is the weight of the wet sample and O is the weight of the dried sample. The water absorption rating of the sample is the average of the results obtained from the three specimens tested.

### Water Repellency: Tumble Jar Dynamic Absorption Test

The following test also measures the water-repellent efficacy of finishes applied to fabrics, because the test subjects the treated fabrics to dynamic conditions similar to those often encountered during actual use. The test conforms to AATCC TM70-2015.

According to the present invention, the following is the procedure used to determine the dynamic water absorption rating of a material.
1. During the test, two specimen sets are tested. Each specimen set consists of five 8″×8″ pieces of the material. For each piece that is cut, the corner yarns are removed and, if necessary, a drop of liquid latex or rubber cement is placed at the corners to prevent raveling. Prior to testing, each piece of material is conditioned at 65 + or − 2% relative humidity and at 70 + or − 2° F. for a minimum of four hours. Blotting paper to be used later is also conditioned.
2. The five pieces of each specimen set are rolled together and weighed to the nearest 0.1 gram.
3. Two liters of distilled water at 80 + or − 2° F. is poured into the tumble jar of a dynamic absorption tester. The dynamic absorption tester should consist of a motor driven, 6 liter cylindrical or hexagonal-shaped jar approximately 6″ in diameter and 12″ in length, mounted to rotate end over end at 55 + or − 2 rpm with a constant tangential velocity. The jar may be of glass, corrosion resistant metal, or chemical stoneware.
4. Both specimen sets are placed into the jar and the jar is rotated in the tester for 20 minutes.
5. A piece of one specimen set is then immediately passed through a ringer at a rate of 1″ per second with the edge of the piece parallel to the rolls. The piece is sandwiched between two pieces of unused blotter paper and passed through the ringer again. The piece is left sandwiched between the wet blotters. The process is then repeated for the remaining four pieces of the specimen set. The blotters are removed and the five pieces are rolled together, put in a tared plastic container or gallon-sized zippered plastic bag and the wet specimen set is weighed to the nearest 0.1 gram. The mass of the wet specimen set should not be more than twice its dry mass.
6. Step number five is repeated for the second specimen set.
7. The dynamic water absorption for each specimen set is calculated to the nearest 0.1% using the following equation:

WA=(W−C)/C×100

where
WA=water absorbed, percent
W=wet specimen weight, g
C=conditioned specimen weight, g.
8. The dynamic water absorption of the material is determined by averaging together the water absorbed by each of the two specimen sets.
9. According to the present invention, the dynamic water absorption rating of the material can be determined after laundering the samples in accordance with NFPA 1971, 8-1.2. For instance, the samples can be tested after 10 laundry cycles and after 20 laundry cycles to determine the durability of the water resistant coating.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to a protective garment that is particularly well suited to protecting the user from fluids and providing an impenetrable barrier to many liquids. The present disclosure is also directed to a fabric that includes a water resistant treatment in accordance with the present disclosure. In the past, durable water resistant treatments have typically been formed from a combination of fluorine-based chemistries and components, such as polymers, derived from fossil-based resources. The present disclosure is directed to a water resistant treatment made from a water repellent that is derived from sustainable resources, such as biomass. In one aspect, the water resistant treatment can also be formulated to be substantially non-fluorinated.

Protective garments made in accordance with the present disclosure can be used in all different types of fields and applications. The protective garments, for instance, can be used by healthcare personnel and/or by patients and can include daily medical wear or can include more specialized garments, such as gowns, lab coats, and the like. Protective garments made in accordance with the present disclosure can also include fire safety garments and apparel. Such protective garments can include footwear, trousers, jackets, coats, shirts, headwear, gloves, and the like. The protective garment can be a one-piece jumpsuit or can comprise a uniform, such as a military garment, tactical garment, firefighter garment, industrial garment, police garment, battle dress uniform, and the like.

As described above, protective garments in accordance with the present disclosure are made from a fabric material that includes a water resistant treatment. In accordance with the present disclosure, the water resistant treatment includes a water repellent that is non-fluorinated and at least in part is produced from renewable resources, such as biomass. The water repellent, for instance, can have a mean bio-based carbon content of at least about 25%, such as at least about 30%, such as at least about 35%, such as at least about 40%, such as at least about 45%, such as at least about 50%, such as at least about 55%, such as at least about 60%, such as at least about 65%, such as at least about 70%. The water repellent, for instance, can have a bio-based carbon content of up to 100%.

Bio-based water repellents that can be incorporated into the water resistant treatment composition of the present disclosure include, in one embodiment, an acrylate. In an alternative embodiment, the bio-based water repellent can be a hyperbranched hydrocarbon polymer. In still another embodiment, the bio-based acrylate water repellent can be combined with the bio-based hyperbranched hydrocarbon polymer to form the water resistant treatment composition.

The bio-based acrylate can be, for instance, an alkyl acrylate. The alkyl group, for instance, can have a carbon chain length of from about 1 carbon atom to about 32 carbon atoms including all species therebetween. In one aspect, the alkyl group can be a linear group. Alternatively, the alkyl group can be branched. In one embodiment, the alkyl group on the alkyl acrylate has a relatively small carbon chain length, such as from about C1 to about C8. For instance, the carbon chain length can be less than about 7 carbon atoms, such as less than about 6 carbon atoms, such as less than about 5 carbon atoms, such as less than about 4 carbon atoms. Alternatively, the alkyl group on the acrylate can have a carbon chain length of greater than about 8 carbon atoms, such as greater than about 10 carbon atoms, such as greater than about 12 carbon atoms, such as greater than about 14 carbon atoms, and generally less than about 28 carbon atoms, such as less than about 24 carbon atoms, such as less than about 20 carbon atoms, such as less than about 14 carbon atoms. The alkyl acrylate water repellent, in one embodiment, can have a mean bio-based content of greater than about 20%, such as greater than about 30%, such as greater than about 40%, and less than about 100%, such as less than about 80%, such as less than about 60%, such as less than about 50%.

In addition to an alkyl acrylate water repellent, the present inventors also discovered that another bio-based water repellent based on a hyperbranched hydrocarbon structure can also be very effective at repelling liquids from a fabric while remaining durable and capable of withstanding multiple laundry cycles. The hyperbranched hydrocarbon polymer, for instance, can have a dendritic structure. The hyperbranched hydrocarbon polymer, for instance, can include water repellent end groups. In one embodiment, the hyperbranched polymer is combined with a comb polymer. The comb polymer and the hyperbranched polymer can form a relatively stable microphase for application to textile materials. In one aspect, when a bio-based hyperbranched polymer is present in the water treatment composition, the composition is free of surfactants or emulsifiers which may adversely interfere with the hyperbranched polymer and comb polymer microphase dispersion.

In one embodiment, the hyperbranched polymer can include N-alkyl groups, particularly N-methyl groups. The N-methyl groups can cross-link with the fiber surface, enhancing wash durability. The N-methyl groups can also facilitate the formation of a crystalline structure. For example, after making a bond with fiber surfaces, multiple —CH3 end groups can be aligned to form crystals in order to achieve a high level of wash durability.

In one aspect, the hyperbranched polymer is cationic and is present in a dispersion at a pH of greater than about 4, such as greater than about 5, and generally less than about 7, such as less than about 6.

The bio-based hyperbranched polymer can, in one aspect, have a mean bio-based content of greater than about 40%, such as greater than about 50%, such as greater than about 60%, and generally less than about 100%, such as less than about 90%, such as less than about 80%.

The bio-based water repellent incorporated into the water treatment composition of the present disclosure, in one embodiment, has a relatively low cure temperature. For instance, the cure temperature can be less than about 165° C., such as less than about 155° C., such as less than about 145° C. at cure times of either 5 minutes, 10 minutes, 20 minutes, or 30 minutes. Using a bio-based water repellent with a relatively low cure temperature, for instance, further can reduce energy requirements needed to apply the water resistant treatment composition to a fabric. In addition, in one embodiment, a commercial laundry dryer can be used to cure the composition onto a fabric in forming the water resistant treatment.

In addition to one or more bio-based water repellents, the water treatment composition of the present disclosure, in one embodiment, can be formulated so as to only contain an additional curing agent or curing extender. In general, any suitable curing extender can be used that is capable of affecting the curing properties of the bio-based water repellent. In one embodiment, the curing extender can be a prazole compound, such as a dialkylprazole compound. In one embodiment, the curing extender can be an isocyanate. For instance, a blocked isocyanate may be used, such as an oxime-blocked isocyanate.

In still another embodiment, the curing extender can be any suitable polyurethane oligomer or polymer. In one embodiment, the curing extender can be isocyanate-free such that the water treatment composition does not contain any isocyanate compounds.

In another aspect, the curing extender or crosslinking agent can be a hydrophobically-modified polyacrylic acid polymer powder polymerized in a toxicologically-preferred cosolvent system. The hydrophobically-modified polyacrylic acid polymer allows for lower temperature processing, such as less than 90 degrees C., such as less than 80 degrees C., such as less than 70 degrees C., such as less than 60 degrees C.

In one aspect, the curing extender can be bio-based (such as one or more of the extenders described above) and have a mean bio-based content of greater than about 20%, such as greater than about 40%.

The amount of curing extender contained in the water treatment

composition can vary depending upon factors including the type of water repellent used, the type of fabric being treated, and the desired result. In one aspect, the curing extender is present in the water resistant treatment composition in relation to one or more bio-based water repellents such that the weight ratio is from about 1:2 to about 1:25. For instance, the weight ratio between the curing extender and one or more bio-based water repellents can be from about 1:3 to about 1:7.

In one embodiment, the water resistant treatment composition does not contain any further components and still can produce a water resistant treatment on a fabric that not only repels liquids but is durable over multiple laundry cycles. For instance, in one embodiment, the water resistant treatment composition does not contain any emulsifiers or surfactants. For instance, the water resistant treatment composition can be free of anionic surfactants, non-ionic surfactants, cationic surfactants, zwitterionic surfactants, amphoteric surfactants, and the like. The water resistant treatment composition can also be formulated so as to not contain any softeners. In other embodiments, however, one or more of the above ingredients may be included.

Of particular advantage, the water resistant treatment composition of the present disclosure can not only be formulated using bio-based components, but can also be formulated to be non-fluorinated or substantially free of fluorocarbon chemicals.

Substantially free, as used herein, indicates that the fabric contains fluorocarbon chemicals in an amount less than about 1000 ppb, such as in an amount less than about 500 ppb, such as in an amount less than about 400 ppb, such as in an amount less than about 250 ppb, such as in an amount less than about 100 ppb. In one embodiment, the durable water resistant composition is free or is substantially free of perfluorinated carboxylic acids, such as free or substantially free of perfluorooctanoic acid. For example, perfluorooctanoic acid or any perfluorinated carboxylic acids may be present in the durable water resistant composition and/or in a treated fabric in an amount less than about 500 ppb, such as in an amount less than about 400 ppb, such as in an amount less than about 250 ppb, such as in an amount less than about 100 ppb.

In another embodiment, the durable water resistant treatment composition can be free or substantially free of polyfluoroalkyl compounds, including C6 compounds. For instance, the durable water resistant composition and/or the treated fabric can contain one or more polyfluoroalkyl compounds in an amount less than about 500 ppb, such as in an amount less than about 400 ppb, such as in an amount less than about 250 ppb, such as in an amount less than about 100 ppb.

As described above, the durable water resistant treatment composition of the present disclosure can optionally contain various other ingredients such as a softener. The softener, for instance, may comprise an emulsion of a polyalkylene polymer. The softener is generally nonionic. In one embodiment, the softener is a polyethylene polymer, such as a lower molecular weight polyethylene polymer.

In one embodiment, the water resistant treatment composition can also contain a water repelling adjuvant. The water repelling adjuvant, for instance, can comprise a wax. The wax, for instance, can be a paraffin wax or can be a polyolefin wax, such as a polyethylene wax.

The durable water resistant treatment composition can also contain fillers, particularly natural based filler materials, such as microcrystalline cellulose. The natural based filler material can enhance the surface roughness in order to provide a high level of hydrophobicity.

The composition of the present disclosure can also contain various other optional ingredients. For instance, composition can also include natural-based insect repellent/insecticide chemistries such as oil of lemon eucalyptus, peppermint oil, synthetic permethrin, IR 3535, etofenprox, hydrophobic silicone softeners and the like. Other components can include flame retardants (e.g., phosphorous compounds, melamine derivatives, antimony compounds), optical brighteners (e.g., bis-benzoxazoles, phenylcoumarins, and bis-(styryl)biphenyls)), and/or anti-static additives (e.g., such as fatty acid esters, ethoxylated alkylamines and ethoxylated alcohols, alkylsulfonates and alkylphosphates). Any of the above components can be contained in the composition in an amount from about 100 ppm to about 5% by weight, such as from about 0.001% by weight to about 2% by weight.

The components contained in the water resistant treatment composition can be combined with water and optionally a wetting agent, such as isopropyl alcohol for application to a fabric. The relative amounts of each component can vary depending on the particular formulation.

When included in the formulation, the softener can generally be present in amounts less than the water repellent. For example, in one embodiment, the softener can be present in relation to the water repellent in a weight ratio of from about 1:1 to about 1:4, such as from about 1:1.5 to about 1:3.

When formulating the water resistant treatment composition, the concentration of the components contained in the composition that is applied to the fabric can depend upon numerous factors, including the manner in which the composition is applied to the fabric, the type of fabric being treated, and the amount of the composition that is to be loaded into the fabric after drying. In general, one or more bio-based water repellents are present in the water resistant treatment composition in an amount greater than about 0.5% by weight, such as in an amount greater than about 1% by weight, such as in an amount greater than about 2% by weight, such as in an amount greater than about 3% by weight, such as in an amount greater than about 4% by weight, such as in an amount greater than about 5% by weight, such as in an amount greater than about 6% by weight, such as in an amount greater than about 7% by weight, such as in an amount greater than about 8% by weight, such as in an amount greater than about 9% by weight, such as in an amount greater than about 10% by weight, such as in an amount greater than about 11% by weight, such as in an amount greater than about 12% by weight, such as in an amount greater than about 13% by weight, such as in an amount greater than about 14% by weight, such as in an amount greater than about 15% by weight. One or more bio-based water repellents are generally present in the water resistant treatment composition in an amount less than about 40% by weight, such as in an amount less than about 30% by weight, such as in an amount less than about 20% by weight, such as in an amount less than about 10% by weight, such as in an amount less than about 8% by weight. The amount of curing extender present in the composition can generally depend upon the amount of one or more water repellents present. In general, the curing extender can be present in an amount greater than about 0.1% by weight, such as in an amount greater than about 0.3% by weight, such as in an amount greater than about 0.5% by weight, such as in an amount greater than about 0.8% by weight, and generally in an amount less than about 8% by weight, such as in an amount less than about 5% by weight, such as in an amount less than about 3% by weight, such as in an amount less than about 2% by weight.

The remainder of the composition can comprise one or more solvents including water alone or in combination with a wetting agent. The wetting agent, for instance, can be an alcohol being present in an amount of from about 0.01% by weight to about 1% by weight, such as in an amount from about 0.07% by weight to about 0.3% by weight. Once applied to a fabric and dried, the water and wetting agent are removed from the fabric.

In one embodiment, the water resistant treatment composition can be combined with one or more antimicrobial agents in order to provide fabrics and garments with antiviral properties. The antimicrobial agents can be combined directly with the water resistant treatment composition or can be applied to the fabric separately.

In general, any suitable antimicrobial agent can be incorporated into the final product. For instance, the antimicrobial agent can comprise a silver-containing material, such as silver metal particles or silver ion polymers, quaternary compounds such as quaternary silane or quaternary ammonium cations, pyrithione compounds including zinc pyrithione and/or sodium pyrithione, chitosan, copper-containing materials, triclosan, or mixtures thereof.

Each antimicrobial agent can be present on the fabric in any suitable amount depending upon the particular application and the particular antimicrobial agent selected. For example, the antimicrobial agent can be present on the fabric in an amount greater than about 0.001% by weight, such as in an amount greater than about 0.01% by weight, such as in an amount greater than about 0.1% by weight, such as in an amount greater than about 0.5% by weight, such as in an amount greater than about 0.7% by weight, such as in an amount greater than about 1% by weight, such as in an amount greater than about 2% by weight, such as in an amount greater than about 3% by weight. Each antimicrobial agent is generally present on the fabric in an amount less than about 30% by weight, such as in an amount less than about 20% by weight, such as in an amount less than about 10% by weight, such as in an amount less than about 5% by weight, such as in an amount less than about 3% by weight, such as in an amount less than about 1.5% by weight, such as in an amount less than about 1% by weight.

The composition of the present disclosure can contain one or more antimicrobial agents. In one aspect, the antimicrobial agent comprises a metal ion. In one aspect, for example, a metal ion containing ion-exchange agent is used. Alternatively, the antimicrobial agent can be a water soluble salt or water soluble particles containing free metal ions. Metal ions that may be included in the antimicrobial agent include, for instance, silver, copper, zinc, gold, iron, cobalt, nickel, manganese, antimony, bismuth, barium, cadmium, chromium, and mixtures thereof. In one aspect, the metal ions are silver, copper, gold, zinc and combinations thereof. In one particular embodiment, for instance, the antimicrobial agent can comprise silver ions alone or in combination with copper ions, zinc ions, or both copper ions and zinc ions.

Ion-exchange type antimicrobial agents are typically characterized as comprising an ion-exchange capable ceramic particle having ion-exchanged antimicrobial metal ions, i.e., the antimicrobial metal ions have been exchanged for (replaced) other ions in and/or on the ceramic particles. While these materials may have some surface adsorbed or deposited metal, the predominant antimicrobial effect is as a result of the ion-exchanged antimicrobial metal ions released from within the ceramic particles themselves.

Antimicrobial ceramic particles include, but are not limited to zeolites, calcium phosphates, hydroxyapatite, zirconium phosphates and other ion-exchange ceramics. These ceramic materials come in many forms and types, including natural and synthetic forms. For example, the broad term “zeolite” refers to aluminosilicates having a three dimensional skeletal structure that is represented by the formula: XM2/nO—Al2O3—YSiO2—ZH2O wherein M represents an ion-exchangeable ion, generally a monovalent or divalent metal ion; n represents the atomic valence of the (metal) ion; X and Y represent coefficients of metal oxide and silica, respectively; and Z represents the number of water of crystallization. Examples of such zeolites include A-type zeolites, X-type zeolites, Y-type zeolites, T-type zeolites, high-silica zeolites, sodalite, mordenite, analcite, clinoptilolite, chabazite and erionite.

Generally speaking, the ion-exchange type antimicrobial agents used in the practice of the present invention are prepared by an ion-exchange reaction in which non-antimicrobial ions present in the ceramic particles, for example sodium ions, calcium ions, potassium ions and iron ions in the case of zeolites, are partially or wholly replaced with the antimicrobial metal ions, for example, copper and/or silver ions. The combined weight of the antimicrobial metal ions will be in the range of from about 0.1 to about 35 wt. %, preferably from about 1 to 25 wt. %, more preferably from about 2 to about 20 wt. %, most preferably, from about 2.5 to 15 wt. %, of the ceramic particle based upon 100% total weight of ceramic particle. Where the ceramic particles include two or more different antimicrobial metal ions, each antiviral metal ion is typically present in and amount of from about 0.1 to about 25 wt %, preferably from about 0.3 to about 15 wt. %, most preferably from about 2 to about 10 wt. % of the ceramic particle based on 100% total weight of the ceramic particle.

In one aspect, the particles can contain both silver ions in combination with copper ions and optionally with an organosilane-based quaternary ammonium compound. In these instances, the weight ratio of silver to copper ions is from 1:10 to 10:1, preferably from 5:1 to 1:5, most preferably from 2.5:1 to 1:2.5. In an especially preferred embodiment, the ceramic particle contains from about 0.3 to about 15 wt. % of silver ions and from about 0.3 to about 15 wt, % of copper ions in a weight ratio of 5:1 to 1:5. Exemplary compositions are disclosed in US 2006/0156948A1 and 2008/0152905A1, both of which are incorporated herein by reference in their entirety.

The antimicrobial ceramic particles may also contain other ion-exchanged ions for various purposes, particularly ions that improve color stability of the fabrics and/or overall stability and/or ion release characteristics of ceramic particles. An exemplary and preferred other ion is ammonium ion.

The preferred antimicrobial ion-exchange agents are the antimicrobial aluminosilicates, specifically the zeolites. A number of different grades and types of antiviral zeolites are commercially available including about 0.6% silver; about 2.5% silver; about 2.5% silver, 14% zinc, and 0.5%-2.5% ammonium ions; and about 6.0% copper and about 3.5% silver.

The above metal ions are described as having antimicrobial properties. The metal ions are very effective against all different types of microorganisms, including bacteria, viruses, and/or fungi.

The one or more antimicrobial agents as described above can be applied to the fabric material in accordance with the present disclosure in an amount sufficient to destroy and kill microorganisms that come in contact with the fabric material, including the Coronavirus. In general, the one or more antimicrobial agents are applied to the fabric material in an amount from about 0.05 gsm to about 2 gsm, including all increments of 0.05 gsm there between. For instance, the one or more antimicrobial agents can be applied to a fabric material in an amount greater than about 0.1 gsm, such as greater than about 0.3 gsm, such as greater than about 0.5 gsm, such as greater than about 0.7 gsm, and generally less than about 1.5 gsm, such as less than about 1.3 gsm, such as less than about 1 gsm, such as less than about 0.7 gsm.

In one particular aspect, the composition contains zeolite particles containing silver in an amount from about 3% to about 15% by weight, such as in an amount from about 7% to about 12% by weight. The composition can also contain zeolite particles containing both silver and copper ions generally in an amount from about 6% by weight to about 20% by weight, such as in an amount from about 11% by weight to about 17% by weight.

As described above, the water resistant treatment composition of the present disclosure can be applied to fabrics and/or garments using various methods and techniques. Prior to applying the water resistant treatment composition, the fabric material can optionally be scoured using, for instance, an alkaline solution. After being scoured, the fabric material can be put on a tenter frame, dried, and heat seat. For instance, after scouring, the fabric material can be dried so that the moisture level is substantially equivalent to the natural moisture level of the fibers used to make the fabric material. For instance, the moisture level can be less than about 10% by weight, such as less than about 7% by weight, and generally greater than about 3% by weight.

After the fabric material has been dried and heat set, the water resistant treatment composition can be applied to at least one side of the fabric material. Although the composition can be sprayed onto the fabric material as a liquid or foam or printed onto the fabric material, in one aspect, the fabric material is dipped into a bath containing the water resistant treatment composition.

The amount of the water resistant treatment composition applied to the fabric material will depend upon the particular formulation and the particular application. The dry add on can be greater than about 0.5% by weight, such as greater than about 1% by weight, such as greater than about 1.5% by weight, such as greater than about 2% by weight, such as greater than about 2.5% by weight, such as greater than about 3% by weight, and generally less than about 7% by weight, such as less than about 5% by weight, such as less than about 4% by weight, such as less than about 3.5% by weight.

After the water resistant treatment composition is applied to the fabric material, the fabric material is then heated to a temperature sufficient for the treatment composition to dry and/or cure. After the composition is dried, a water resistant treatment in accordance with the present disclosure remains on the fabric. The water resistant treatment can be impregnated into the interstices of the fabric. For instance, in one embodiment, the water resistant treatment does not form a coating on the fabric, such as a continuous coating. The fabric material then can be used in constructing various protective garments in accordance with the present disclosure.

As described above, in one embodiment, the water resistant treatment composition can be applied to a fabric material. In an alternative embodiment, the water resistant treatment composition can be applied to a garment. The water resistant treatment composition can be applied to a garment prior to the garment being worn. Alternatively, the water resistant treatment composition can be applied to a garment that has been previously worn and laundered in order to boost to the water repellent properties of the garment which may have degraded due to wear.

The water resistant treatment composition of the present disclosure, for instance, is particularly well suited for being applied to fabrics and garments in any suitable garment extractor, including a standard washing machine that is used to clean laundry. In addition, because the bio-based water repellents have a relatively low cure temperature, the durable water resistant treatment composition can be dried and cured by loading the wet garments and fabrics into a standard dryer for clothing.

For example, the garment may contact the water resistant treatment while located in a garment extractor. In this respect, a garment treated in accordance with the present disclosure may be loaded into a garment extractor by a user or by an apparatus. As used herein, a garment extractor indicates any apparatus or device that may contact and/or clean a garment using liquid, gas, or a combination thereof, such as a garment washing device (e.g., washing machine). In this respect, the garment extractor may be a front loading washing machine, a side loading washing machine, a top loading washing machine, a stone washing machine, or more generally any type of washing machine suitable for the washing of a garment. The garment extractor may be pressurized or unpressurized.

In one aspect, the garment extractor may be an industrial dry cleaning machine, such as a gaseous or liquid carbon dioxide industrial cleaning machine.

The period of time the water resistant treatment is in contact with the garment may be referred to as the dwell time. The water resistant treatment may contact the garment for a selectively chosen dwell time such that the water resistant composition impregnates the fibers of the garment. For instance, when the water resistant treatment contacts the garment in a garment extractor, the water resistant treatment may contact the garment for a dwell time of about 10 minutes to about 120 minutes, such as about 15 minutes or more, such as about 25 minutes or more, such as about 30 minutes or more, such as about 35 minutes or more, such as about 45 minutes or more, such as about 60 minutes or more, such as about 75 minutes or more, such as about 90 minutes or more. Generally, the water resistant treatment contacts the garment for a dwell time of less than about 120 minutes, such as about 105 minutes or less, such as about 90 minutes or less, such as about 75 minutes or less, such as about 60 minutes or less, such as about 45 minutes or less, such as about 35 minutes or less, such as about 30 minutes or less, such as about 25 minutes or less, such as about 15 minutes or less.

The water resistant treatment may be at a temperature of about 5° C. to about 95° C., such as about 5° C. or more, such as about 10° C. or more, such as about 20° C. or more, such as about 30° C. or more, such as about 40° C. or more, such as about 50° C. or more, such as about 60° C. or more, such as about 70° C. or more, such as about 80° C. or more, such as about 90° C. or more. Generally, the water resistant treatment is at a temperature of about 95° C. or less, such as about 90° C. or less, such as about 80° C. or less, such as about 70° C. or less, such as about 60° C. or less, such as about 50° C. or less, such as about 40° C. or less, such as about 30° C. or less, such as about 20° C. or less, such as about 10° C. or less.

The water resistant treatment may comprise any number of compositions. For instance, the water resistant treatment may comprise a solvent and a water resistant concentrate. In this respect, the solvent and the water resistant concentrate may be mixed to form the water resistant treatment. The water resistant treatment may be acidic. In one aspect, a garment extractor may mix the solvent and the water resistant concentrate such that the solvent and the water resistant concentrate form the water resistant treatment. In one aspect, the water resistant treatment of the present disclosure can be formulated to be water-based. In this respect, the solvent may be water. In yet another aspect, the solvent may comprise water, a solvent (e.g., liquid carbon dioxide, liquid silicone, perchloroethylene, a petroleum based compound, trichloroethylene, carbon tetrachloride, 1,1,2-trichlorotrifluoroethane, 1,1,1-trichloroethane, a glycol ether, decamethylcylcopentasiloxane, n-propyl bromide), a detergent, or a combination thereof. In a further aspect, the water resistant treatment may comprise gaseous carbon dioxide.

In one aspect, the solvent may comprise liquid carbon dioxide. In this respect, the water resistant treatment may comprise liquid carbon dioxide and a water resistant concentrate. The utilization of liquid carbon dioxide in the solvent or as the solvent may result in a garment that does not require rinsing after the separation of the garment from the water resistant treatment.

In one aspect, the solvent may comprise a petroleum based compound. In this respect, the solvent may comprise a hydrocarbon, such as an aliphatic hydrocarbon (e.g., isoparaffinic hydrocarbon, cycloparrafinic hydrocarbon).

In one aspect, the solvent may comprise a detergent. In this respect, the detergent may be an anionic detergent, a non-anionic detergent, or a cationic detergent.

After the water resistant treatment has made suitable contact with the garment, the garment may be separated from water resistant treatment. For instance, when the garment is submerged in the water resistant treatment in a garment washing device for a suitable dwell time, the garment may be removed from the washing device after the water resistant composition impregnates the fibers of the garment. The garment may then be loaded into a garment drying device, which is further discussed later in this application.

In one aspect, the garment may be directly loaded into the garment drying device after it is removed from the garment washing device without rinsing the garment. Generally, garments treated with traditional water resistant repellants require rinsing, particularly a thorough rinsing, after being treated with the water resistant repellant because the pH of the treated garment is unacceptable for direct contact with human skin. Indeed, a fabric pH of less than 4 or greater than 8.5 may result in skin itchiness, irritation, and dermatitis. However, the treated garments of the present disclosure unexpectedly demonstrated exceptional post-cure pH values, as observed in the Examples, without the need for rinsing the garment after the separation of the garment from the water resistant treatment. This result is particularly unexpected because the water resistant treatment can be acidic.

Fabric materials treated according to the present can have various liquid resistant properties and can provide a barrier to multiple fluids and liquids that the wearer may contact.

In one embodiment, the fabric material is used to construct protective garments for use in the medical industry. In this application, the protective garment can protect the user from blood, other body fluids, saline solutions and other fluids from penetrating or striking through the fabric. Although the fabric material can be designed to be disposable, in one embodiment, the fabric material and protective garment made from the fabric material are reusable and can undergo multiple laundry cycles and still retain the desired barrier properties.

When used in the healthcare industry, the protective garment of the present disclosure can be rated according to the Association for the Advancement of Medical Instrumentation (AAMI).

The AAMI uses two tests developed by the American Association of Textile Colorists and Chemists (“AATCC”). AATCC 42 measures a material's water resistance by impact penetration. The material to be tested is held at a 45-degree angle while a fixed amount of water is sprayed on it. A blotter affixed under the material is weighed before and after the water is sprayed to determine how much water penetrated the fabric. According to the present AAMI standard, the material is classified as Level 1 if the weight gain of the blotter is no more than 4.5 grams.

For present AAMI Level 2, the material to be tested must satisfy two AATCC tests—AATCC 42 and AATCC 127. The first test, AATCC 42, is the same as that used for Level 1 except that the increase in the blotter's weight must be no more than 1 gram. The additional test is AATCC 127 which measures a material's resistance to water penetration under hydrostatic pressure. Under this test, a sample of the material to be tested is clamped in place horizontally on the bottom of a glass, metered cylinder. Hydrostatic pressure is increased steadily by increasing the amount of water in the cylinder. To be acceptable for use as a present AAMI Level 2 barrier, the material must be able to resist the penetration of water when it reaches a level of 20 cm.

For present AAMI Level 3, both of the AATCC test methods described above must be satisfied, similar to the requirements to meet the present AAMI Level 2. For AATCC 42, the maximum blotter weight gain is the same as that for Level 2 (i.e., 1 gram). For AATCC 127 to be acceptable for use as a present AAMI Level 3 barrier, the level of water in the cylinder used in AATCC 127 must be at least 50 cm.

For present AAMI Level 4, the AAMI uses two tests developed by the American Society for Testing Materials (“ASTM”)-F1670/F1670M-17a for liquid penetration (i.e., surrogate blood) and F1671/F1671M-13 for viral penetration (i.e., bacteriophage Phi-X174). For surgical gowns and other protective apparel, the material must meet the viral challenge of F1671/F1671M-13 which measures the resistance of materials to bloodborne pathogens using viral penetration at 2 psi and ambient pressure. For surgical drapes and accessories, the material must meet the liquid challenge of F1670/F1670M-17a which measures the resistance of drape materials to penetration by synthetic blood at 2 psi and ambient pressure. For both tests, the results are expressed as pass or fail rather than in terms of a material's resistance.

For ASTM F1671/F1671M-13, the material must pass the test for resistance to penetration by bacteriophage Phi-X174. A sample of the material to be tested is placed vertically in a test cell as a membrane between the media challenge (i.e., liquid) and a viewing chamber. Materials that permit penetration during an hour of a prescribed series of changes in air pressure are not considered suitable for use. For ASTM F1670/F1670M-17a, the material must pass the test for resistance to penetration by synthetic blood. As in the test for viral penetration, the material to be tested is mounted in a vertical position on a cell that separates the surrogate blood liquid challenge and the viewing chamber. The test is terminated if visible liquid penetration occurs at any time before or during 60 minutes of changes in pressure and atmospheric protocols.

Protective garments made in accordance with the present disclosure can pass the AAMI Level 1, the AAMI Level 2, the AAMI Level 3 and/or the AAMI Level 4 requirements as described above. In particular, the protective garment (including all seams) can display an impact penetration according to Test AATCC 42 of one gram or less and can display a hydrostatic pressure according to Test AATCC 127 of 50 cm or greater. In addition, the protective garment can also pass European standards, such as test EN13795 and EN14126.

When designed to pass the AAMI Level 4 requirements, the fabric material can be a laminate. For example, laminates comprising (i) a woven or non-woven fabric and (ii) an extruded film can be used. In one aspect, the laminate can include a film layer positioned between two outer fabric layers. The film layer can be a microporous poly-tetrafluoroethylene (PTFE) film layer or made from polyester elastomers which are all block copolymers containing 60-70% of a hard (crystalline) segment of polybutylene terephthalate and the balance a soft (amorphous) segment based on long chain polyether glycols. While the soft segments are preferably based on long chain polyethylene glycols, comparable long chain polyether glycols, such as long chain polypropylene glycols, also are suitable. The one or more outer fabric layers can be nonwoven, woven or knitted fabrics. The woven or non-woven fabric used in the laminate can be any fabric which is suitable for use in protective garments for the outdoors (e.g. rainwear, skiwear) or a medical setting. Examples of suitable fabrics are polyester, nylon, polypropylene, Dupont Sontara.RTM., tricot knit cloth nylon or brushed polyester.

As described above, protective garments of the present disclosure can be designed to be reusable. For example, protective garments made according to the present disclosure can maintain a desired AAMI Level rating even after 60 laundry cycles, such as greater than 75 laundry cycles, such as greater than 85 laundry cycles, such as greater than 100 laundry cycles, such as even greater than 105 laundry cycles. As used herein, a laundry cycle with respect to an AAMI Level rating is according to “Care Code ST.” A laundry cycle not only includes laundering of the protective garment but also a sterilization protocol. One laundry cycle in conjunction with a sterilization protocol is as follows:

| | | | | Water | |
|---|---|---|---|---|---|
| | | | Water | Temper- | |
| Operation | Time | | Level | ature | Supplies - 100 lbs |
| 1. Flush | 3 | min | High | Cold | |
| 2. Flush | 3 | min | High | Cold | |
| 3. Break | 10 | min | Low | 160° F. | (8 oz. nonionic detergent - |
| | | | | | 8 oz. alkali Max pH-10.0) |
| 4. Rinse | 3 | min | High | 140° F. | |
| 5. Extract | 3 | min | | | |
| 6. Rinse | 2 | min | High | 120° F. | |
| 7. Rinse | 2 | min | High | 100° F. | |
| 8. Rinse | 2 | min | High | Cold | |
| 9. Sour | 5 | min | Low | Cold | Sour to pH 6.0 (citric acid) |
| 10. Ex- | 3-5 | min | | | |
| tract | | | | | |

Vacuum steam sterilization protocol:

### Temperature: 134° C./274° F.

Exposure Time: 4 minutes
Exhaust Time: 20 minutes

Fabric materials treated in accordance with the present disclosure can have a spray rating of at least 70 or higher, such as at least 80 or higher, such as at least 90 or higher even after ten laundry cycles or twenty-five laundry cycles. In one embodiment, for instance, the fabric can maintain a 100 spray rating after ten laundry cycles. After 50 laundry cycles, the fabric materials treated in accordance with the present disclosure can have a spray rating of at least 70 or higher, such as at least 80 or higher.

Similarly, the fabric material can also display excellent resistance to water absorption. For example, when tested according to the water absorption test (NFPA 1971 8.25), the fabric can have a water absorption of about 15% or less, such as about 10% or less, such as about 5% or less, such as about 4% or less, such as about 3% or less, such as about 2% or less, such as about 1% or less.

The above water absorption properties can be retained by the fabric after 5 laundry cycles, after ten laundry cycles, or after twenty-five laundry cycles. After 50 laundry cycles, the fabric materials treated in accordance with the present disclosure can have a water absorption of less than 5%.

In addition to water, fabric materials treated in accordance with the present disclosure also provide protection against various chemical agents such as acids, alkaline materials, and artificial blood when tested according to test EN ISO 6530. For example, when tested against a 30% sulfuric acid solution, fabric materials made according to the present disclosure can have an index of repellency of greater than about 85%, such as greater than about 90%, such as greater than about 92%, such as greater than about 94%. The fabric material can have an index of penetration when tested against a 30% sulfuric acid solution of less than about 5%, such as less than about 2%, such as less than about 1%, such as less than about 0.5%. When the fabric material is incorporated into a composite, such as a three layer composite, the index of penetration can be 0%.

When tested against a 10% sodium hydroxide solution, fabric materials made according to the present disclosure can display an index of repellency of greater than about 90%, such as greater than about 92%, such as greater than about 94%, such as greater than about 96%, such as greater than about 97%. The fabric materials can display an index of penetration of less than about 2%, such as less than about 1.5%, such as less than about 1%, such as less than about 0.8%.

Fabric materials made according to the present disclosure also display excellent resistance to artificial blood. When tested against artificial blood, for instance, fabric materials made according to the present disclosure can display an index of repellency of greater than about 85%, such as greater than about 87%, such as greater than about 90%, such as greater than about 92%, such as greater than about 94%. The fabric materials can display an index of penetration against artificial blood of less than about 4%, such as less than about 1.5%, such as less than about 1%, such as less than about 0.8%.

The fabric material treated in accordance with the present disclosure can be a single layer fabric or a multilayer fabric. The fibers used to make the fabric can depend upon the particular end use application. The fabric material can also contain a woven fabric, a nonwoven fabric, a knitted fabric, a film, and combinations thereof.

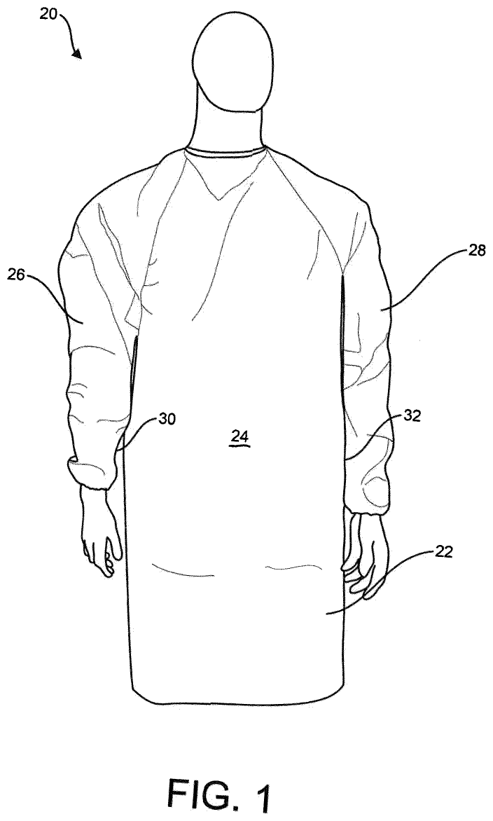

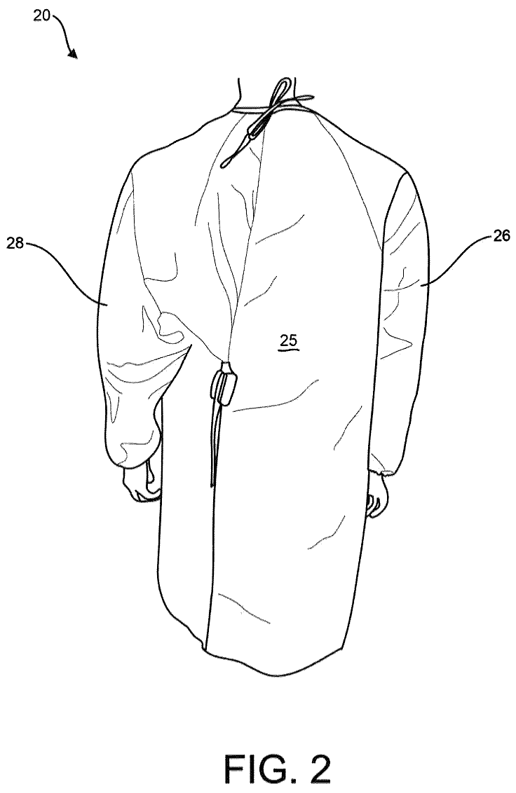

For exemplary purposes only, one embodiment of a protective garment for the medical industry is illustrated in FIGS. 1 and 2. As shown, protective garment 20 can include a body portion 22 that can include a front 24 and a back 25. The body portion 22 can be connected to a first sleeve 26 and a second sleeve 28. The protective garment 20 can be made from a single piece of fabric. In order to form the first sleeve 26 or the second sleeve 28, the fabric can be connected together along a first seam 30 and a second seam 32. Each seam can be formed by stitching the opposing material together. In one embodiment, the seam can be formed by two parallel rows of stitching. The seam can be made according to U.S. Pat. No. 6,680,100, which is incorporated herein by reference.

The fabric that is used to construct the garment illustrated in FIG. 1 can be any suitable fabric material. For example, the fabric can be a woven fabric, a nonwoven fabric, or a knitted fabric.

In one aspect, the protective garment 20 is formed from a polyester woven fabric. For instance, the fabric can contain greater than 80%, such as greater than 90%, such as 100% by weight polyester fibers. The fabric can be formed from polyester yarns. In one aspect, the polyester yarns are formed from continuous filaments, such as polyester multifilament yarns. The yarns in both the warp direction and the fill direction can generally have a relatively low denier. For instance, the yarns can have a denier of less than about 300, such as less than about 200, such as less than about 150, such as even less than about 100. The denier of the yarns is greater than about 10, such as greater than about 50. Each yarn can contain at least about 10 filaments, such as at least about 20 filaments, such as at least about 30 filaments, such as at least about 40 filaments, and generally less than about 100 filaments, such as less than about 70 filaments, such as less than about 60 filaments. In one aspect, the yarn has a denier of from 70 to 75 and contains 30 to 50 filaments per yarn.

In addition to polyester yarns, in one embodiment the fabric can contain anti-static fibers and yarns. For example, anti-static yarns can comprise bicomponent filaments that include a polymer core surrounded by a carbon sheath.

Each yarn can include a single end or can include two ends. Optionally, the yarns can be textured. In such yarns, the filaments are distorted from their generally rectilinear condition to increase the bulk of the yarn and also to provide an ability for a fabric woven therefrom to stretch. A textured yarn may be “set” by heat relaxation to minimize its stretch characteristic, while maintaining its increased bulk, i.e., higher bulked denier.

There are several types of textured yarns capable of being produced by various methods. Different types of textured yarns have different characteristics, some being more expensive than others. The textured yarns that may be employed in the present fabric constructions, or referenced herein, are:
(1) False twist yarn is twisted in one direction, set, then twisted in the opposite direction and set. The twisting, setting, opposite twisting are repeated throughout the length of the yarn.
(2) Core and effect yarn (also known as “core bulked” yarns) is a multiple ended yarn, usually comprising two ends in which one end is essentially straight. The filaments of other end are distorted around the core end and sometimes through the core end.
(3) Air texturized core and effect yarn—is a core and effect yarn in which distortion of the filaments is done by air jet means. An air texturized core and effect yarn has unique properties which distinguish it from other textured yarns. These unique properties have been found effective in attaining the ends herein sought.

In addition to using relatively low denier yarns, the fabric material of the present disclosure can also have a relatively high yarn density. For instance, in the warp direction, the fabric can have greater than about 80 yarns per inch, such as greater than about 100 yarns per inch, such as greater than about 110 yarns per inch, such as greater than about 120 yarns per inch, such as greater than about 130 yarns per inch, such as greater than about 140 yarns per inch, such as greater than about 150 yarns per inch, and generally less than about 200 yarns per inch, such as less than about 180 yarns per inch. In the fill direction, the yarn density can be greater than about 60 yarns per inch, such as greater than about 65 yarns per inch, such as greater than about 70 yarns per inch, such as greater than about 75 yarns per inch, such as greater than about 80 yarns per inch, such as greater than about 85 yarns per inch, and generally less than about 120 yarns per inch, such as less than about 100 yarns per inch, such as less than about 95 yarns per inch.

The fabric material of the present disclosure can also be calendered. Calendering can increase the barrier properties and reduce the permeability of the fabric. During calendering, the fabric is passed between a pair of pressure rolls wherein at least one of the rolls is heated. When a woven polyester fabric is calendered, the fabric is compressed and its density is increased as the interstices between the yarns and the filaments of the yarns are decreased.

The above fabric material represents just one type of fabric that can be treated in accordance with the present disclosure to produce the protective garment as shown in FIG. 1. In general, any suitable fabric can be treated in accordance with the present disclosure and formed into a protective garment for use in the medical field or in other fields. For instance, in other embodiments, the fabric material can be made exclusively from cotton fibers or can be made from a combination of cotton fibers and polyester fibers. The fibers used to make the fabric material can be staple fibers or can be continuous filament fibers that are used to make monofilament yarns and multifilament yarns. In still another embodiment, the fabric material can be made from a polyamide, such as nylon. The fabric material can be made exclusively from the polyamide fibers or can be a fiber blend of polyamide fibers with cellulose fibers, polyester fibers, or combination of all three fibers. Cellulose fibers that may be used include cotton fibers or regenerated cellulose fibers such as rayon fibers and viscose fibers.

Protective garments for use in medical industry generally have a light basis weight. For example, the basis weight can be from about 0.5 osy to about 4 osy.

In another aspect, the protective garment of the present disclosure can be designed to be worn by those in the fire service industry. For example, the fabric material can contain flame resistant fibers, such as inherently flame resistant fibers or fibers treated with a flame retardant.

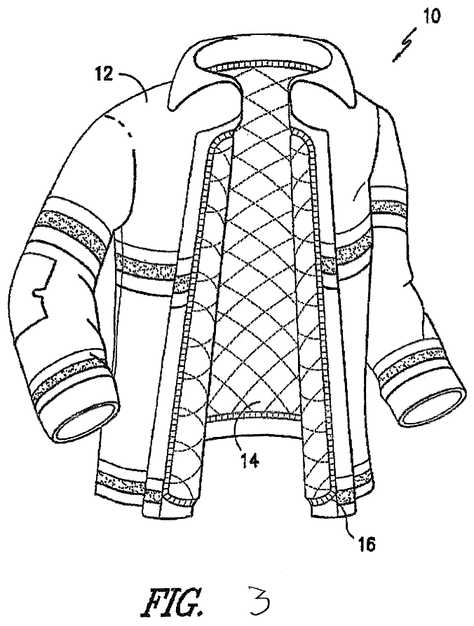

For example, the fabric may be used to construct a garment worn by firefighters. For instance, referring to FIG. 3, one embodiment of a fireman turnout coat 10 constructed in accordance with the present disclosure is illustrated. Garment 10 includes a relatively tough outer shell 12 having a liner assembly 14 located therein. Outer shell 12 and liner assembly 14 together function to protect a wearer from heat and flame such as may be encountered during firefighting activities.

In the illustrated embodiment, liner assembly 14 is constructed as a separate unit that may be removed from outer shell 12. A zipper 16 is provided for removably securing liner assembly 14 to outer shell 12. It should be appreciated, however, that other suitable means of attachment, including a more permanent type of attachment such as stitches, may also be used between liner assembly 14 and outer shell 12.

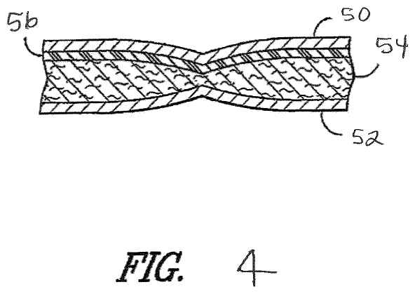

The construction of protective garment 10 is more particularly illustrated in FIG. 4. As shown, liner assembly 14 includes a plurality of material layers quilted together. The outermost layers, i.e. lining layers 50 and 52, are connected together about their respective peripheries to form an inner cavity. A thermal barrier layer 54 and a moisture barrier layer 56 are located within the inner cavity, as shown. Typically, lining layer 50 will be adjacent the wearers body during use, whereas lining layer 52 will be adjacent outer shell 12.

Thermal barrier layer 54 can be made from various materials. For instance, an aramid felt, such as a felt produced from NOMEX meta-aramid fibers obtained from DuPont can be used. The felt functions as an insulator to inhibit transfer of heat from the ambient-environment to the wearer.

Moisture barrier 56 is preferably a suitable polymeric membrane that is impermeable to liquid water but is permeable to water vapor. Moisture barrier layer 56 is designed to prevent water contacting the exterior surface of garment 10 from reaching the wearer while at the same time permitting the escape of perspiration from the wearer.

In the embodiment described above, the fireman turnout coat 10 includes multiple layers. In other embodiments, however, it should be understood that a coat or jacket made in accordance with the present disclosure may include a single layer or may include an outer shell attached to a liner. For example, wildland firefighter garments are typically one or two layers.

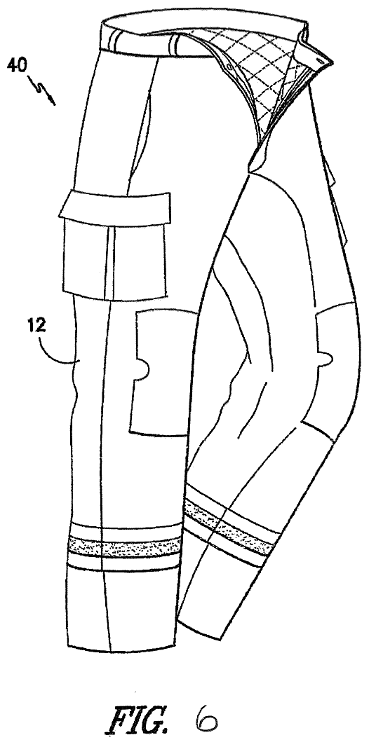

Referring to FIG. 6, a pair of trousers made in accordance with the present disclosure is shown. The trousers 40 as shown in FIG. 6 can be used in conjunction with the turnout coat 10 illustrated in FIG. 3. The trousers 40 also include an outer shell 12 made from the fabric of the present disclosure.

Any of the fabric layers illustrated in the figures can be treated in accordance with the present disclosure. For instance, the outer shell 12, the lining layer 50, the lining layer 52, and/or the thermal barrier layer 54 as shown in FIGS. 3 and 6 can be treated in accordance with the present disclosure with a water resistant and antimicrobial treatment. The fabric material can be a woven or knitted fabric and, in one embodiment, contains inherently flame resistant fibers. For example, the fabric material can contain inherently flame resistant fibers in an amount greater than about 50% by weight, such as in an amount greater than about 60% by weight, such as in an amount greater than about 70% by weight, such as in an amount greater than about 80% by weight, such as in an amount greater than about 90% by weight, such as in an amount greater than about 95% by weight. In one embodiment, for instance, the fabric material is made exclusively from inherently flame resistant fibers or contains inherently flame resistant fibers in an amount up to about 97% by weight, such as about 98% by weight.

The inherently flame resistant fibers can include, for instance, aramid fibers such as para-aramid fibers and/or meta-aramid fibers. Other inherently flame resistant fibers include polybenzimidazole (PBI) fibers or poly(p-phenylene-2,6-bezobisoxazole) (PBO fibers) and the like. In one embodiment, for instance, the fabric material only contains aramid fibers such as para-aramid fibers alone or in combination with meta-aramid fibers. In still another embodiment, the fabric material contains only meta-aramid fibers. In still another embodiment, the fabric material contains aramid fibers in combination with PBI fibers. The PBI fibers can be present in the fabric material, for instance, in an amount greater than about 20% by weight, such as in an amount greater than about 25% by weight, such as in an amount greater than about 30% by weight, such as in an amount greater than about 35% by weight, such as in an amount greater than about 40% by weight, such as in an amount greater than about 45% by weight, such as in an amount greater than about 50% by weight, and generally in an amount less than about 70% by weight, such as in an amount less than about 60% by weight.

In addition to any of the inherently flame resistant fibers described above, the fabric material may contain other fibers. For instance, the fabric material may also include fibers treated with a flame retardant such as FR cellulose fibers including FR viscose fibers and FR rayon fibers. In addition, the fabric material may include antistatic fibers, nylon fibers, and the like. For example, a fabric materials treated in accordance with the present disclosure can contain nylon fibers in an amount up to about 20% by weight. For instance, nylon fibers can be present in an amount of from about 18% to about 2% by weight, such as from about 15% to about 8% by weight.

The yarns used to produce the fabric material can vary depending upon the particular application and the desired result. In one embodiment, for instance, the fabric material may contain only spun yarns, may contain only filament yarns, or may contain both spun yarns and filament yarns. The number ratio between spun yarns and filament yarns, for instance, can be from about 1:1 to about 10:1. For example, in one embodiment, the fabric material may contain spun yarns to filament yarns in a number ratio of from about 2:1 to about 4:1. When the fabric material is a woven fabric, the fabric can have any suitable weave such as a plain weave, a twill weave, a rip stop weave, or the like.

In one embodiment, the filament yarns may be made from an inherently flame resistant material. For example, the filament yarns may be made from an aramid filament, such as a para-aramid or a meta-aramid filament.

In other embodiments, the filament yarns may be made from other flame resistant materials. For instance, the filament yarns may be made from poly-p-phenylenebenzobisoxazole fibers (PBO fibers), and/or FR cellulose fibers, such as FR viscose filament fibers.

The filament yarns can be combined with spun yarns. Alternatively, the fabric material can be made using only filament yarns or only spun yarns. In accordance with the present disclosure, the spun yarns, in one embodiment, may contain polybenzimidazole fibers alone or in combination with other fibers. For example, in one embodiment, the spun yarns may contain polybenzimidazole fibers in combination with aramid fibers, such as para-aramid fibers, meta-aramid fibers, or mixtures thereof.

Instead of or in addition to containing polybenzimidazole fibers, the spun yarns may contain aramid fibers as described above, modacrylic fibers, preoxidized carbon fibers, melamine fibers, polyamide imide fibers, polyimide fibers, and mixtures thereof.

In one particular embodiment, the spun yarns contain polybenzimidazole fibers in an amount greater than about 30% by weight, such as in an amount greater than about 40% by weight. The polybenzimidazole fibers may be present in the spun yarns in an amount less than about 60% by weight, such as in an amount less than about 55% by weight. The remainder of the fibers, on the other hand, may comprise para-aramid fibers.

In one embodiment, various other fibers may be present in the spun yarns. When the fabric is used to produce turnout coats for firemen, the spun yarns can be made exclusively from inherently flame resistant fibers. When the fabric is being used in other applications, however, various other fibers may be present in the spun yarns. For instance, the spun yarns may contain fibers treated with a fire retardant, such as FR cellulose fibers. Such fibers can include FR cotton, FR rayon, FR acetate, FR triacetate, and FR lyocell, and the like. The spun yarns may also contain nylon fibers if desired, such as antistatic fibers.

The basis weight of the fabric material can vary depending upon the particular type of protective garment being produced. The weight of the outer shell material, for instance, is generally greater than about 4 ounces per square yard, such as greater than about 5 ounces per square yard, such as greater than about 5.5 ounces per square yard, such as greater than about 6 ounces per square yard and generally less than about 8.5 ounces per square yard, such as less than about 8 ounces per square yard, such as less than about 7.5 ounces per square yard.

In another aspect, the fabric material treated in accordance with the present disclosure is a liner fabric. The liner fabric, for instance, can be positioned adjacent to the wearer's body during use. The lining fabric can be made from a combination of spun yarns and filament yarns as described above. The filament yarns can have a size of greater than about 100 denier, such as greater than about 200 denier, and less than about 500 denier, such as less than about 400 denier. In order to increase the lubricity of the liner fabric, the spun yarns and filament yarns can be woven together such that the filament yarns comprise more than about 50% of the surface area of one side of the fabric. For instance, the filament yarns may comprise greater than about 60%, such as greater than about 70%, such as greater than about 80% of one side of the fabric. The side of the fabric with more exposed filament yarns is then used as the interior face of the garment. The filament yarns provide a fabric with high lubricity characteristics that facilitates donning of the garment. For example, the lining fabric can be woven together using a twill weave, such as a 2×or 3×1 weave. The lining fabric can have a basis weight of less than about 5 ounces per square yard, such as less than about 4 ounces per square yard, and generally greater than about 2.5 ounces per square yard, such as greater than about 3 ounces per square yard.

In another aspect, the fabric material treated in accordance with the present disclosure is the barrier layer 54 as shown in FIG. 4. Barrier layer 54, for instance, can comprise a batting material, such as a felt.

The present disclosure may be better understood with reference to the following example.

### EXAMPLE

Various different fabric samples were treated with different compositions and tested for water resistance.

Four different fabric samples were tested as follows:

| Sample No. | |
|---|---|
| 1 | Untreated fabric made from aramid fibers |
| 2 | Untreated fabric made from aramid fibers |
| 3 | Fabric made from aramid fibers and treated |
| | with a commercial durable water resistant |
| | composition and laundered until NFPA |
| | Absorbency is about 5% |
| 4 | Fabric made from aramid fibers and treated |
| | with a commercial durable water resistant |
| | composition and laundered until NFPA |
| | Absorbency is about 5% |

Two different water resistant treatment compositions were formulated in accordance with the present disclosure and applied to the four fabrics above. As shown in the table above, the water resistant treatment compositions of the present disclosure were applied to untreated fabrics and to fabrics that had been previously treated with a durable water resistant composition but then laundered many laundry cycles where the liquid resistant properties have degraded to determine if the water resistant treatment compositions of the present disclosure can be applied over a degraded durable water resistant composition for improving the water resistant properties of the fabric. The degraded durable water resistant composition can be fluorine free or can contain fluorine, such as a fluoropolymer.

The four fabric samples as described above were tested for spray rating and water absorbency and the following results were obtained:

Before reapplication

| Sample No. | AATCC 22 Spray Score | NFPA Absorbency % |
|---|---|---|
| 1 | 0-50 | 34.68 |
| 2 | 0-50 | 41.71 |
| 3 | 70 | 5.06 |
| 4 | 70 | 4.71 |

In the first set of experiments, the water resistant treatment composition applied to the four fabric samples contained 5% by weight of a bio-based hyperbranched cationic hydrocarbon polymer in combination with a comb polymer. The hyperbranched polymer had a mean bio-based content of 74%. The composition also contained 1% by weight of a dimethylprazole blocked isocyanate, 0.15% by weight isopropyl alcohol, and the remainder water. The water resistant treatment composition was applied to the fabrics using an industrial extractor at 175° F. for a 30-minute cycle with no rinse cycle. After application, the fabrics were placed in a dryer and tumble dried for 30 minutes at 190° F. The fabrics were then tested for spray rating and water absorbency initially and after 25 laundry cycles. The following results were obtained:

| | formula applied @ UniMac extractor | | | |
|---|---|---|---|---|
| | 0X | | 25X | |
| Sample | AATCC 22 | NFPA | AATCC 22 | NFPA |
| No. | Spray Score | Absorbency % | Spray Score | Absorbency % |
| 1 | 100 | 0.69 | 80 | 5.25 |
| 2 | 100 | 0.53 | 90 | 4.02 |
| 3 | 100 | 0.79 | 100 | 0.91 |
| 4 | 100 | 0.96 | 90 | 0.81 |

The same four fabric samples were also treated with a second water resistant treatment composition formulated in accordance with the present disclosure. In the second set of experiments, the water resistant treatment composition contained 4% by weight of a bio-based alkylacrylate water repellent that had a mean bio-based content of 41%. The composition also contained 1% by weight of the dimethylprazole blocked isocyanate and 0.15% by weight of isopropyl alcohol. The reminder of the composition was water. The above composition was applied to the four fabric samples using the same process as described above (commercial washing machine followed by dryer). The fabrics were tested for spray rating and water absorbency initially and after 25 laundry cycles. The following results were obtained:

| | formula applied @ UniMac extractor | | | |
|---|---|---|---|---|
| | 0X | | 25X | |
| Sample | AATCC 22 | NFPA | AATCC 22 | NFPA |
| No. | Spray Score | Absorbency % | Spray Score | Absorbency % |
| 1 | 100 | 1.31 | 90 | 1.23 |
| 2 | 100 | 0.68 | 90 | 0.34 |
| 3 | 100 | 0.49 | 90 | 0.7 |
| 4 | 100 | 0.55 | 70 | 1.9 |

During preparation of the fabric samples, it was noticed that the water resistant treatment compositions of the present disclosure did not have any adverse impact on the fabrics and did not have any negative impact on the fabric feel or fabric color. As shown above, the water resistant treatment of the present disclosure actually performs better than many commercial durable water resistant treatments used in the past.

In another experiment, the water-resistant composition was pad applied to a 7.0 osy untreated aramid fabric which contained 10% by weight of a bio-based alkyl acrylate water repellent. The water repellent chemistry had a mean bio-based content of 41%. The composition also contained 2% by weight of a dimethylprazole blocked isocyanate, 0.64% by weight isopropyl alcohol, and the remainder water. The water resistant treatment composition was applied to the fabrics using the conventional industrial pad-dry-cure application. After impregnation with chemistry, the fabrics were dried using multiple heating boxes at about 180 C. The fabrics were then tested for spray rating and water absorbency initially and after 10, 30, and 50 laundry cycles. The following results were obtained:

| | Wet | Dry | | | | | |
|---|---|---|---|---|---|---|---|
| Number | Weight | Weight | % Water | | | | |
| of Wash | (g) | (g) | Absorption | Average | Spray test | | |
| 0X | 2.82 | 2.79 | 1.0753% | 2.14% | 100 | 90 | 90 |
| | 2.9 | 2.82 | 2.8369% | | | | |
| | 2.86 | 2.79 | 2.5090% | | | | |
| 10X | 2.95 | 2.92 | 1.0274% | 1.27% | 90 | 90 | 100 |
| | 2.9 | 2.86 | 1.3986% | | | | |
| | 2.93 | 2.89 | 1.3841% | | | | |
| 30X | 2.99 | 2.9 | 3.1034% | 2.88% | 70 | 70 | 70 |
| | 2.94 | 2.85 | 3.1579% | | | | |
| | 2.99 | 2.92 | 2.3973% | | | | |
| 50X | 2.97 | 2.95 | 0.6780% | 5.22% | 70 | 70 | 80 |
| | 2.85 | 2.7 | 5.5556% | | | | |
| | 2.9 | 2.65 | 9.4340% | | | | |

It was noticed that pad application with water resistant treatment compositions of the present disclosure did not have any adverse impact on the fabric flexibility, fabric strength, air permeability and fabric shade. It was observed that the water resistant treatment of the present disclosure performs better than many commercial durable water resistant treatments used in the past.

In another experiment, the water-resistant composition was pad applied to a 99% polyester/1% carbon fabric which contained 8% by weight of a bio-based alkyl acrylate water repellent. The water repellent chemistry had a mean bio-based content of 82%. The composition also contained 2% by weight of a dimethylprazole blocked isocyanate, 0.9% by weight isopropyl alcohol, and the remainder water. The composition contained 0.9% by weight of acetic acid, and the remainder water. The water resistant treatment composition was applied to the fabrics using the conventional industrial pad-dry-cure application. After impregnation with chemistry, the fabrics were dried using multiple heating boxes at about 180 C. The fabrics were then tested for spray rating (AATCC 22) and hydrostatic pressure (AATCC 127) initially and after 5, 10, 20, 50, 75 and 100 laundry cycles. The following results were obtained.

| Number of wash | Original | 5X | 10X | 20X | 50X | 75X | 100X |
|---|---|---|---|---|---|---|---|
| Hydrostatic Pressure | 635 | 600 | 742 | 736 | 704 | 710 | 725 |
| (AATCC 127) | | | | | | | |
| Spray Test (AATCC | 100 | 100 | 100 | 100 | 100 | 100 | 100 |
| 22) | | | | | | | |

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

What is claimed:

1. A protective garment comprising:
a fabric material comprising a woven fabric, a knitted fabric, a nonwoven fabric, or combinations thereof, the fabric material including a water resistant treatment, the water resistant treatment comprising a water repellent, the water repellent having a mean bio-based carbon content of at least about 25%, the fabric material containing fluorine in an amount less than about 500 ppm, and wherein the fabric material displays a water absorbency of less than about 15% after five laundry cycles.

2. A protective garment as defined in claim 1, wherein the water repellent has a mean bio-based carbon content of at least about 30%.

3. A protective garment as defined in claim 1, wherein the water repellent comprises an acrylate.

4. A protective garment as defined in claim 1, wherein the water repellent comprises a hyperbranched hydrocarbon polymer with methyl end groups.

5. A protective garment as defined in claim 4, wherein the hyperbranched hydrocarbon polymer has a dendritic structure.

6. A protective garment as defined in claim 4, wherein the water repellent further comprises a comb polymer.

7. A protective garment as defined in claim 4, wherein the hyperbranched hydrocarbon polymer includes water repellent end groups.

8. A protective garment as defined in claim 1, wherein the water resistant treatment further comprises a curing extender.

9. A protective garment as defined in claim 8, wherein the curing extender comprises a dialkylprazole compound or a blocked isocyanate.

10. A protective garment as defined in claim 8, wherein the water resistant treatment includes the curing extender and the water repellent at a weight ratio of from about 1:2 to about 1:25.

11. A protective garment as defined in claim 1, wherein the water resistant treatment does not form a continuous coating on a surface of the fabric material.

12. A protective garment as defined in claim 1, wherein the fabric material displays a spray rating of at least 80 after 25 laundry cycles and displays a water absorption of less than about 5% after 25 laundry cycles.

13. A protective garment as defined in claim 1, wherein the fabric material comprises greater than about 50% by weight inherently flame resistant fibers.

14. A protective garment as defined in claim 13, wherein the inherently flame resistant fibers contained in the fabric material comprise para-aramid fibers, meta-aramid fibers, polybenzimidazole fibers, poly(p-pheylene-2,6-bezobisoxazole fibers or mixtures thereof.

15. A protective garment as defined in claim 13, wherein the inherently flame resistant fibers contained in the fabric material comprise a mixture of aramid fibers and polybenzimidazole fibers.

16. A protective garment as defined in claim 1, wherein the fabric material is comprised of spun yarns and multifilament yarns.

17. A protective garment as defined in claim 1, wherein the protective garment is a single fabric layer garment, the single fabric layer being the fabric material.

18. A protective garment as defined in claim 1, wherein the fabric material has a basis weight of from about 5 osy to about 8.5 osy and exhibits an abrasion resistance of greater than 90,000 cycles when tested according to ASTM D4966 Test Method.

19. A protective garment as defined in claim 1, wherein the protective garment comprises a lab coat or a medical garment.

20. A protective garment as defined in claim 1, wherein the protective garment comprises a public service uniform or a fire service garment.

21. A process for increasing the water resistance of a protective garment comprising:
loading a protective garment into a garment washing device;
mixing an aqueous composition with a water resistant concentrate in the garment washing device, the water resistant concentrate being free of fluoropolymers and comprising a water repellent and a curing extender, the water repellent having a bio-based carbon content of at least about 25%, the water resistant concentrate combining with the aqueous composition to form a water resistant composition;
contacting the protective garment with the water resistant composition in the garment washing device, the protective garment being formed from a fabric material, the water resistant composition impregnating the fabric material;
drying the protective garment in a garment drying device such that the water resistant composition is cured and affixed to the fabric material in the form of a water resistant treatment.
